(19) United States
(12) Patent Application Publication
(10) Pub. No.: US 2012/0227554 A1
(43) Pub. Date: Sep. 13, 2012

(54) GROOMING DEVICE WITH LEVELING INDICATORS

(76) Inventor: Jack Beech, Southlake, TX (US)

(21) Appl. No.: 13/402,843

(22) Filed: Feb. 22, 2012

Related U.S. Application Data
(60) Provisional application No. 61/449,814, filed on Mar. 7, 2011.

(51) Int. Cl. B26B 19/48; B26D 1/01; G08B 21/00; B26B 21/42

(52) U.S. Cl. 83/13; 30/123; 30/34.05; 340/689

(57) ABSTRACT

A grooming device includes a level sensor and at least two light emitting diodes operatively connected to the level sensor to indicate the level state of the grooming device. By activation of a power switch, current is permitted to flow from a power supply to the level sensor. The level sensor is thus powered to enable determining whether the grooming device is in a level orientation. In response to this determination, the sensor sends a signal to at least one of the light emitting diodes indicating to the user of the device whether the device is level.

### CROSS REFERENCE TO RELATED APPLICATIONS

This application claims the priority benefit of U.S. Provisional Application No. 61/449,814, filed on Mar. 7, 2011 which is incorporated herein by reference in its entirety.

### BACKGROUND OF THE INVENTION

The present invention relates to the field of grooming devices such as shavers, razors and beard trimmers. With these known devices, a person grooming themselves may inadvertently cut their hair at an unslightly, oblique angle. Providing these devices with one or more level sensors and level indicators would allow a user to know the device was not level and enable him to re-orient the device to an appropriate level position to cut hair to a horizontal or vertical line.

### SUMMARY OF THE INVENTION

Broadly, an embodiment of the present invention generally provides a shaving device having a leveling feature. The leveling feature may include a pair of differently colored integral light emitting diode (LED) lights that can signal whether or not the shaving blade of the shaving device is in a tilted or level position on the shaver's beard.

### BRIEF DESCRIPTION OF THE DRAWINGS

FIG. 1 is a side view of a shaving device with LED leveling indicators according to an exemplary embodiment of the invention.

FIG. 2 is a front view of the shaving device of FIG. 1.

FIG. 3 is a side view of the shaving device of FIG. 1.

FIG. 4 is a front view of a beard trimmer with the LED leveling indicators present invention.

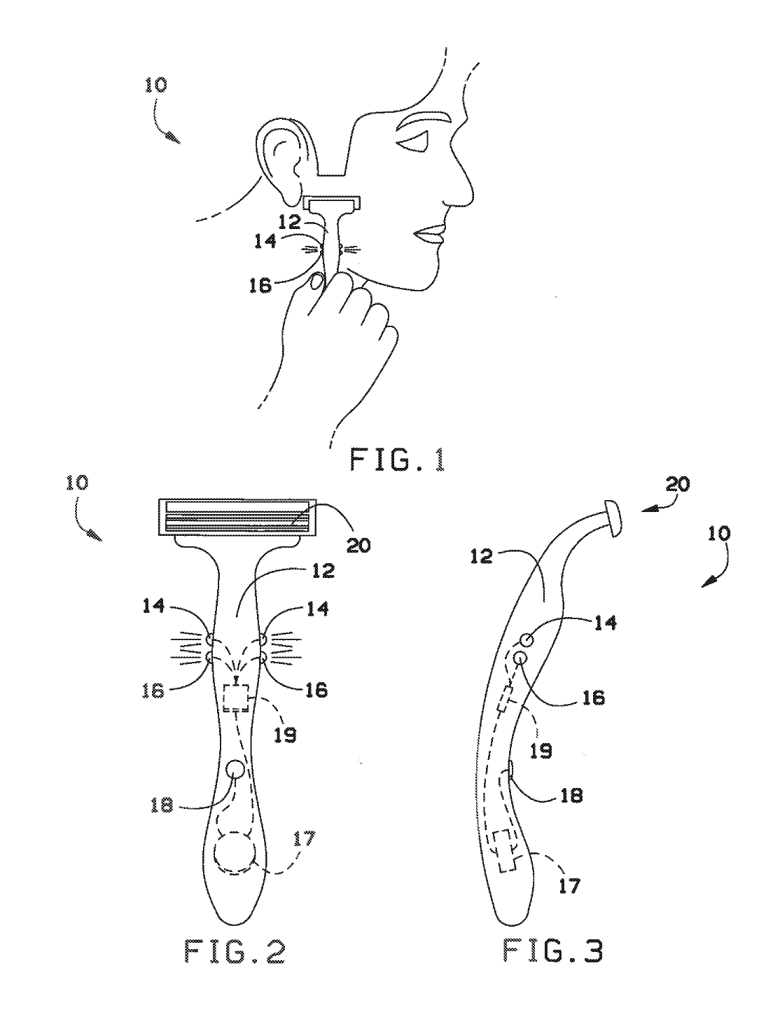

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

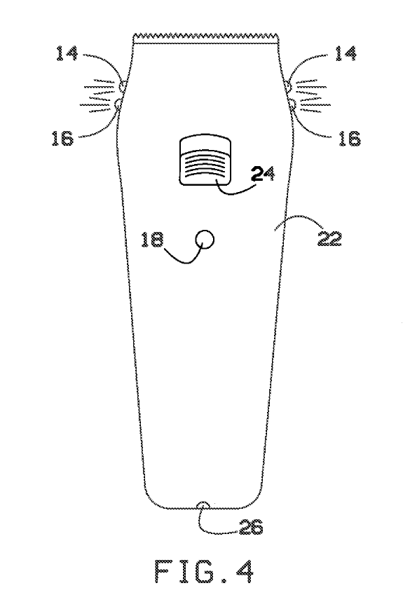

According to an embodiment of the invention, the device includes a shaving device 12 that can be a razor or beard trimmer (see FIG. 4) that includes a leveler 19 in wing LED lights that can be operated by pressing a power button 18 on the razor or beard trimmer. The leveler is configured so that when the power button 18 is pressed, power is allowed to flow from power supply 17 to the LEDs. An LED of one color lights up if the razor or beard trimmer shaving blade 20 is tilted with respect to the shaver's beard line and an LED of a different color lights up if the razor or beard trimmer shaving blade 20 is straight or level with respect to the beard line.

For example, a red LED indicator may light if the shaving device is tilted and a green LED indicator may light if the shaving device is level with respect to the shaver's face. The beard line may be the shaver's sideburns, for example. These features of the shaving device 12 can ensure that the shaver is cutting his sideburns or other areas of the beard in a straight line.

To use the shaving device 12, the user may place the LED lighted leveling razor or beard trimmer 12 close to the beard on his face and press a power button 18 on the razor or trimmer to light up an LED. If the LED emits a green light, the shaver can then proceed to shave the area with confidence that he is shaving his beard in a straight line. If the LED emits a red light, he can then adjust the angle of the razor to the beard until the light is green. The device can be manufactured by those skilled in the arts of electronic lighting and applied to a commercially available razor.

In an alternative embodiment, the leveling system according to the present invention is applied to an electric beard trimmer 22. in this embodiment, a separate leveling switch 24 is provided. Beard trimmer 22 may be used normally without switch 24 but when switch 24 is actuated, one of LEDs 14 or 16 lights up according to the correspondence of LEDs 14 and 16 with level or unlevel indications. For instance, when switch 24 is actuated and beard trimmer 22 is not level, red LEDs 14 light up to indicate beard trimmer 22 is not level. Accordingly, when switch 24 is depressed and beard trimmer 22 is level, green LEDs 16 light up to indicate beard trimmer 22 is level and trimming may continue.

The above-described embodiments of the invention are presented for purposes of illustration and not of limitation. Let it be understood that the steps disclosed may be performed in a different order and remain within the scope of the present invention.

I/We claim:

1. A grooming system comprising:
a grooming device having a handle;
a level sensor incorporated into the razor or beard trimmer and capable of determining a level condition of the grooming system;
wherein said level condition is chosen from true and false;
a plurality of light emitting diodes operatively connected to the level sensor and adapted to emit a plurality of colors of light;
wherein said true level condition is associated with a first color of said plurality of colors and said false level condition is associated with a second color of said plurality of colors;
a power source for providing power to said level sensor and said light emitting diodes;
at least one power switch mounted on the grooming device and capable of opening and closing a circuit to respectively prohibit and permit electricity to flow from said power source to said level sensor;
whereby, when said at least one power switch is actuated to permit electricity to flow, said level sensor receives power, a level condition is determined and one or more of said plurality of light emitting diodes emit light of one of said first and second colors.

2. The grooming device of claim 1, wherein said first color is green.

3. The grooming device of claim 1, wherein said second color is red.

4. The grooming device of claim 1, wherein said grooming device is a razor.

5. The grooming device of claim 1, wherein said grooming device is a heard trimmer.

6. A shaving device comprising:
a razor or beard trimmer having a handle;
a level sensor incorporated into the razor or beard trimmer;
light emitting diode lights connected to the level sensor and adapted to emit two different light colors;
switches mounted on the razor or beard trimmer that send power to operate the light emitting diode lights,
whereby when the light emitting diode lights are powered on by means of the switches, the level sensor sends a signal to the light emitting diode lights to emit one color if the shaving device is in a level position and another color if the shaving device is tilted, so that the shaver can ensure he is shaving his beard in a straight line.

7. A method of grooming, said method comprising the steps of:
holding a grooming device against a body portion of a user having hair, said holding being at any random orientation;
activating a power switch mounted on the grooming device to close an open circuit to permit current flow from a power source to a level sensor;
determining, with said level sensor a level condition of said grooming device, wherein said level condition is chosen from true or false;
sending, in response to a true level condition, a signal to a first light emitting diode to emit light of a first color;
sending, in response to a false level condition, a signal to a second light emitting diode to emit light of a second color;

8. The method of grooming according to claim 7, further comprising the steps of:
observing light emitted by one of said first or second light emitting diodes;
determining, from said light, whether the grooming device is in a level orientation;
grooming said body portion if said grooming device is in a level orientation;
re-orienting said grooming device relative to said body portion if said grooming device is not in a level orientation.

9. A method of grooming as set forth in claim 8 wherein said first color is green.

10. A method of grooming as set forth in claim 8 wherein said second color is red.
